(19) United States
(12) Patent Application Publication
(10) Pub. No.: US 2014/0299518 A1
(43) Pub. Date: Oct. 9, 2014

(54) MAGNETIC DRUM FOR THE MAGNETIC SEPARATION OF IRON PARTICLES INCLUDING AT LEAST 18 STRAIGHT MAGNETIC PLATES

(71) Applicant: Luis Cavero Rosales, Santiago (CL)

(72) Inventor: Luis Cavero Rosales, Santiago (CL)

(21) Appl. No.: 14/355,719

(22) PCT Filed: Dec. 29, 2011
(86) PCT No.: PCT/CL2011/000084

§ 371 Date: May 1, 2014

(30) Foreign Application Priority Data
Nov. 1, 2011 (CL) 2935-2011

(51) Int. Cl. B03C 1/12

(52) U.S. Cl. CPC B03C 1/12
USPC 209/214; 209/219; 29/428

(57) ABSTRACT

A magnetic drum for magnetic separation of iron particles from iron sands, which includes an outer body or hollow cylindrical casing; two side covers, one for each end of the casing; and an inner body or core which includes sheet-metal discs, evenly distributed and connected to a central shaft, and at least 18 straight magnetic plates which are positioned radially on the outer surface of the core and which are supported by the discs. The invention also describes the magnetic separation system for the magnetic separation of iron particles from iron sands, which includes a magnetic drum such as described above, two boxes with the corresponding support and rotation bearings thereof, positioned at either end of the drum, two gear motors with the corresponding shafts and cog belts, two metal delivery boxes; an electrical panel having variable frequency drives, a loading bin and a flow regulator. In addition, the invention describes a method for assembling the magnetic separation system for the magnetic separation of iron particles from iron sands and the magnetic separation method for separating iron particles from iron sands.

### CROSS REFERENCE TO RELATED APPLICATION

This application is a national stage entry of PCT/CL2011/000084 filed Dec. 29, 2011, under the International Convention claiming priority over Chilean Application No. 2935-2011 filed Nov. 1, 2011.

### FIELD OF THE INVENTION

The invention relates to the magnetic separation of iron from iron sands.

The present invention relates to a magnetic drum for the magnetic separation of iron, including the manufacturing process of the mentioned drum and the system for magnetic separation of iron from iron sands.

### BACKGROUND OF THE INVENTION

Magnetic separation is a process used for separation of solid particles not bigger than 7 mm, where one of the solids to be separated is iron or it has magnetic properties. In general, a process for magnetic separation consists of bringing a magnet to the mixture of solids in order to generate a magnetic field which attracts iron particles and leaves behind nonferrous particles. The efficacy of the procedure will depend on the capacity of the magnet and the amount of iron particles present in the mixture, i.e. on the concentration of iron particles in the mixture.

File JP2009172589 describes a magnetic separator with a rotating drum, which contains an inner rotating cylinder with 2 or 3 magnets and an external cylinder made of a non-magnetic material which rotates concentrically around the inner cylinder. In the inner cylinder, the magnets are arranged circumferentially.

File JP2001121028 relates to a magnetic classifier which includes a first and a second fixed disc comprising a magnetic material. A series of first and second permanent annular magnets remain fixed to the inner surface opposite the first and second discs and a protective covering comprising a non magnetic material which continuously covers the peripheric outer part of the first and second permanent magnets. The first and second permanent magnets include a part that generates magnetism from which the same magnetic poles are opposite in polarity to one another through the orifice, in order to generate magnetic fields outside the radial direction.

File JP 10165838 describes a device which consists of a rotating drum in which the low quality material to be classified is directly fed and on which a number of recovering chutes for the recovery of classified material are arranged under the rotating drum; a pipe made of non magnetic material within the rotating drum and a safety pipe to protect the first pipe; in the inner space of the rotating drum there is a rotating rotor which contains a number of permanent magnets arranged in the peripheric direction with similar poles adjacent to each other.

The patent file U.S. Pat. No. 4,693,812 relates to a magnetic separator of materials which includes a drum axially inclined, arranged for the axial rotation within the curvature of an arched structure of a magnet, which axially spans within the drum an it is placed in a closed space joined to the outer surface of the drum. The structure of the magnet comprises a series of arched magnet yokes axially spanned, where each one comprises an axial laminate to form subassemblies of an arched magnet, which are alternately polarized in opposite axial directions. Each of the subassemblies comprises an arched magnet axially polarized and inserted between an arched pair with soft concentrated magnetic flow, which presents respective axial thickness between 5 and 20 percent of half the axial thickness of the inserted magnets.

File CL 33.035 relates to a roller to be used in a magnetic separator made of permanent magnetic layers which have opposite polarities in opposite phases, and ferromagnetic layers between adjacent layers of the same polarity facing one another, in such a way that the ferromagnetic layers alternate in the polarity of their edges exposed to the surface of the roller, where the ferromagnetic layers are made as thin as possible and their exposed sides cover 30% or less of the surface of the roller that is covered by both layers, and the magnetic layers are made of an appropriate permanent magnetic material.

Even though all separators described above separate magnetic particles from mixtures which contain both magnetic and non magnetic particles, there is still need of more effective devices to separate magnetic particles and which are able to separate magnetic particles, both in low magnetic particle concentration mixtures and high magnetic particle concentration mixtures.

Based on the above, primarily in the state of the art there is no magnetic separator able to effectively separate magnetic particles when the magnetic particles present low concentrations in the mixture.

Therefore, a goal of the present invention is to provide a magnetic drum which allows separating iron particles and which is adequate to separate iron particles in low concentrations. Specifically, it is intended to provide a magnetic drum that allows separating iron from iron sands, including those sands having low percentage of iron.

Another goal of the present invention is to provide a method for the manufacturing of a magnetic drum.

Furthermore, one more goal of the present invention is to provide a method to separate iron particles from solid mixtures, especially from iron sands.

### SUMMARY OF THE INVENTION

The present invention relates to a magnetic drum for the magnetic separation of iron comprising an outer body or casing, and an inner body or core, and which also includes a central shaft which in turn has several discs of equal diameter, embedded at even distances, all along the central shaft. Parallel to the central shaft are the plates with magnets as long as the cylinder. The plates are attached to the perimeter contours of the discs. The plates with magnets or magnetic bars are evenly distributed concerning the perimeter of the discs, and between a bar and the next there must be a clearance.

### BRIEF DESCRIPTION OF THE DRAWINGS

The invention will be described next according to the attached drawings, in which:

FIGS. 1 and 8 show a view of the outer body or casing of the magnetic drum of the present invention;

FIGS. 2 and 3 show views of the magnetic drum core of the present invention, with and without magnetic bars;

FIG. 4 is a view of finished magnetic drums of the present invention;

FIGS. 5 and 6 show views of the magnetic drum installed in its metal case;

FIG. 7 is another view of the magnetic drum installed in its metal case;

FIG. 9 shows a plan view of the magnetic drum core; and

FIG. 10 is another view of the magnetic drum installed in its metal case.

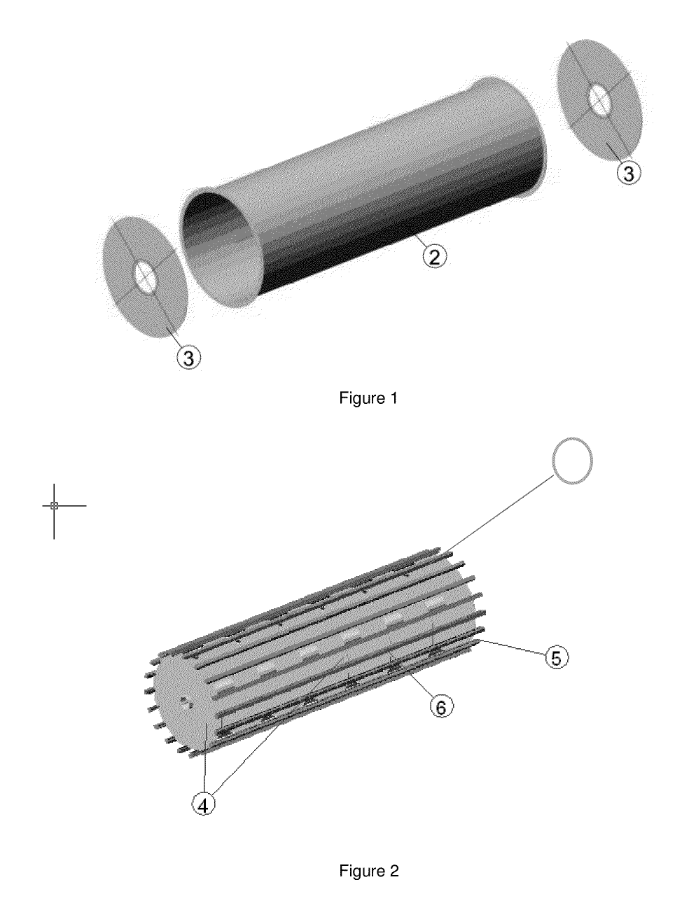

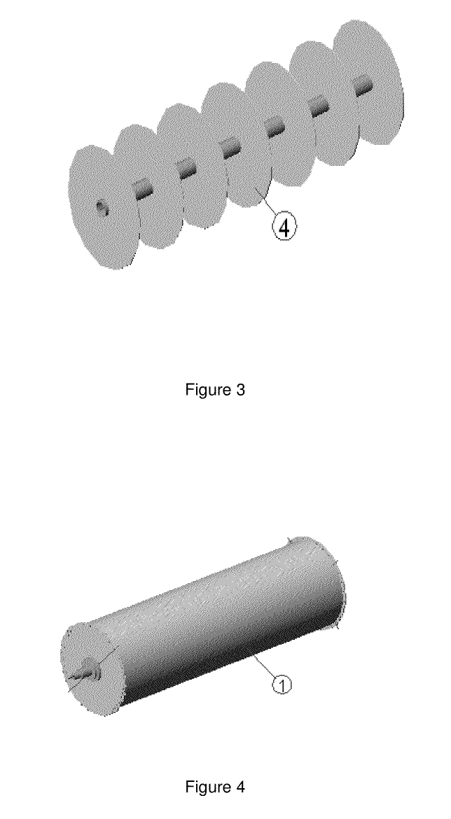

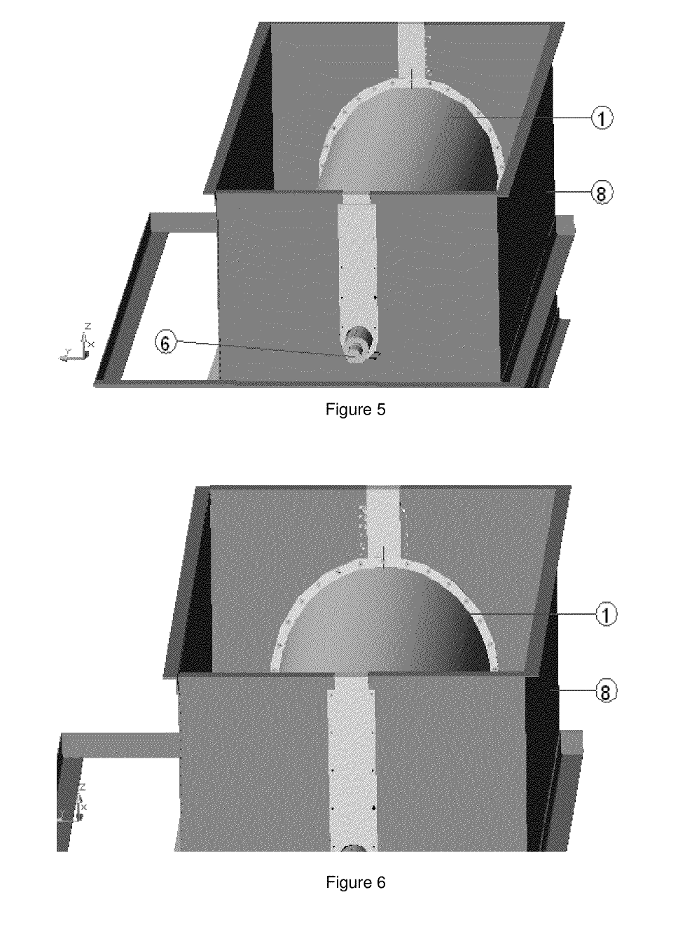

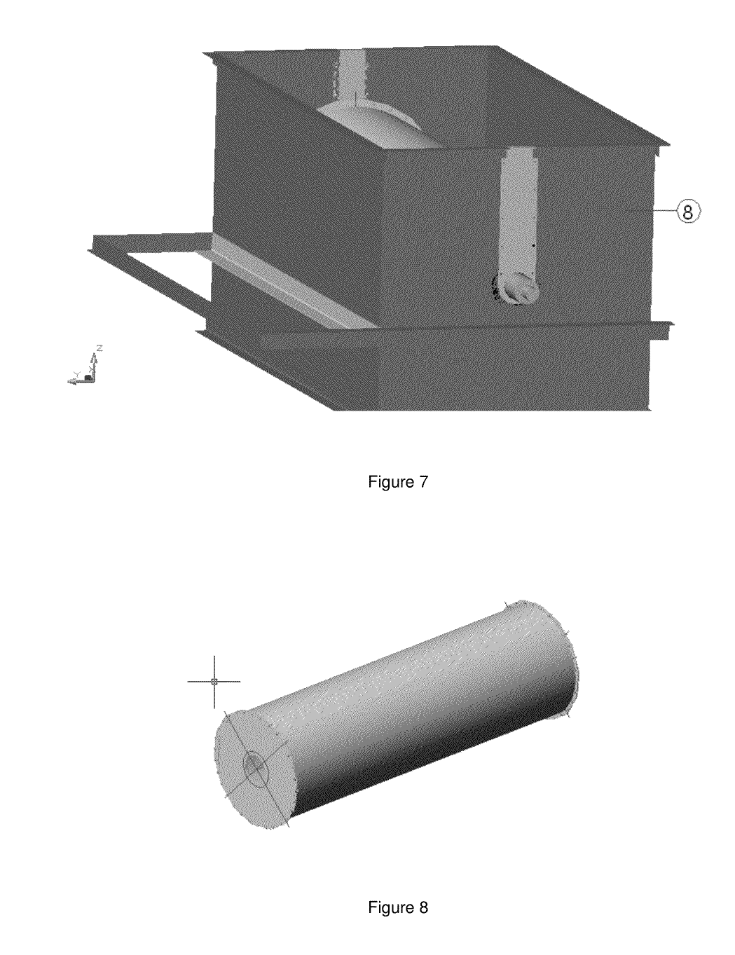

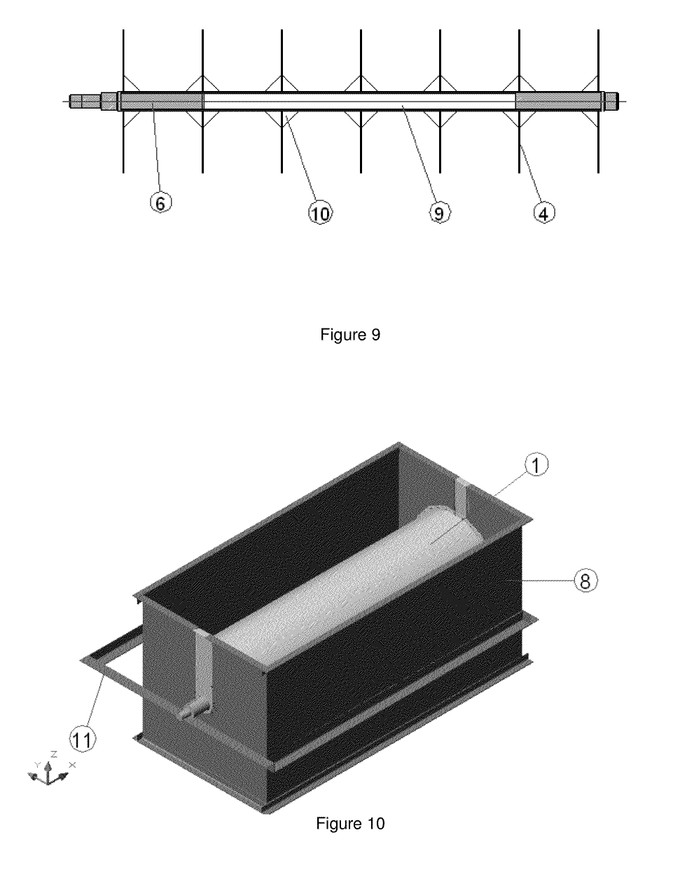

### DETAILED DESCRIPTION OF THE INVENTION

The present invention relates to a magnetic drum (1) for magnetic separation of iron, which comprises an outer body or cylindrical casing (2) with end covers (3) in each of its ends; and an inner body or core (7) consisting of at least eight discs (4) approximately, with their corresponding disc reinforcements (10); a central shaft (6) along the complete core; a tube (9) which covers the central part of the shaft; and at least 18 to 20 plates (5) located on the outer surface of the core in longitudinal direction of the core.

In addition, the present invention relates to a system for magnetic separation of iron which includes the magnetic drum (1); boxes with supporting and rotating bearings to support the drum; a metal box (8) for holding and protecting the drum;

two gear motors with their corresponding shafts, drive chains and cog belts; two conveyor belts installed under the metal box; two metal delivery boxes for receiving the ore yielded by the magnetic drum (rejection and/or concentrate); an electrical panel; a loading bin installed on the upper part of the magnetic drum; and a flow regulator.

Furthermore, the present invention describes a method for assembling the system for magnetic separation of iron particles.

In addition, the present invention refers to the magnetic separation method for the separation of iron particles from iron sands.

Magnetic Drum

The magnetic drum (1) comprises an outer body or casing (2) made of stainless steel in a hollow cylindrical shape, smooth-walled, with a flat flange at each end. The casing is approximately 3,000 mm long and approximately 920 mm in diameter. Each of the flat flanges has perforations along the entire diameter that secure the end covers (3) at each of the ends. The covers are made of stainless steel and are approximately 940 mm in total diameter, their perimeter comprises a flat flange with perforations identical to the perforations of the casing. The fixing between the casing and the covers is made with bolts and stainless steel nuts.

In the inner part, the drum has a magnetic core (7) made of normal structural iron, which is formed by at least eight sheet discs (4) approximately, which are approximately 2 mm thick and approximately 890 mm in diameter evenly distributed and having their corresponding reinforcement discs (10), and which are attached to a central shaft (6) made of chrome-nickel steel of approximately 3,400 mm in length and approximately 120 mm in diameter, wherein the shaft has a tube (9) covering the central part of its body; and at least 18 to 20 magnetic straight plates (5) of approximately 3,000 mm in length placed radially on the external surface of the core with a spacing of about 100 to 140 mm between a plate and the other and which are supported by the discs. The role of the tube (9) is to spin the inner disk and the magnets which are attached to the plates, which in turn are attached to the discs. A side of the shaft acts as a guide to the inner discs and the other side of the shaft is connected to a mechanical system that attaches to the lateral disc of the casing, which spins the core independently. The mechanical system is formed by two lateral supports that incorporate two bearings which spin the core and the casing independently.

### Magnetic Separation System

The magnetic separation system comprises the magnetic drum (1); boxes with their support and rotation bearings placed in each end of the drum, once it has been assembled; a metal box (8) of approximately 3,200 mm in length and approximately 1,620 mm in width for holding and protecting the drum, since it is suitable to be installed on a supporting structure; two gear motors with their corresponding shafts and cog belts; two conveyor belts; two metal delivery boxes for receiving the ore yielded by the magnetic drum (rejection and/or concentrate); an electrical panel having various frequency drives; a loading bin installed on the upper part of the magnetic drum with a funnel shape and whose function is to receive ore to be concentrated which is then distributed on the surface of the magnetic drum, specifically the bin is mounted on the metal box (8) and at the bottom it has an opening from end to end of the funnel, allowing to regulate the feeding toward the magnetic drum; and a flow regulator. The central shaft and the boxes with their support and rotation bearings allow the drum to rotate by spinning the casing in opposite direction to the one of the core. The box and its bearings constitute the support for the core shafts. The magnetic drum has a rotating direction and the magnetic core has a rotating direction opposite to the one of the drum. The core rotates at a speed of between 30 and 90 rpm approximately, to reduce the magnetic fields and thus exercising a uniform magnetic field. The metal box (8) protects, supports and guides the magnetic drum, both ends of the shaft are tamped in a bearing box acting as shaft rests.

### Method for Assembling the System

The method for assembling the system comprises the following steps:

installing the magnetic drum within the metal box to hold the drum, once the drum has been built, placing the drum at the center of the said box, taking precautions to leave a clearance of approximately 500 mm for the delivery of sterile material and a clearance of approximately 200 mm for the iron concentrate;

installing in both lateral ends of the shaft a mechanical system with cog belts based on two gear motors with their corresponding shafts and cog belts which exert the drive movement through the chain, wherein the cog belt diameter and the power of the gear motors will depend on the kind of material to be concentrated, for instance sand or magnetite particulate;

connecting the gear motors to an electrical panel in order to control the start and detention of the operation of the drum;

installing on the upper portion of the magnetic drum a loading bin for the reception of the material to be treated in the drum, whose function is to receive the ore to be concentrated and then distribute it on the surface of the magnetic drum and on the lower portion of the discharge metal boxes; and

installing a flow regulator in the lower part of the loading box, which regulates the feeding in the external surface of the drum, for a feeding flow of approximately 200 tons an hour.

### Magnetic Separation Procedure

The magnetic separation procedure comprises treating material such as iron sands and magnetite particulate not bigger than 12 mm, where the flow ranges to be treated are of approximately 200 tons an hour.

The procedure for magnetic separation of iron particles comprises:

having at least one magnetic separation system which comprises a magnetic drum;

feeding the material to be separated through the loading bin;

starting the system through the electrical panel in such a way that each gear motor gives an inverse movement to the casing and to the core, and when the drum is loaded by the flow regulator the iron concentrate particles follow the rotating direction of the magnetic core and are received by the discharge metal box, which transfers them to the conveyor belt for collection, whereas the (rejected) particles follow the rotating direction of the casing and are received by the other discharge metal box, which transfers them to the rejection or non magnetic particle conveyor belt. The metal box (8) has an angle (11) where the box rests acting as holding structure and which allows supporting and feeding the magnetic drum, also preventing the magnetic material from being lost out of the box during the concentration and/or rejection process, i.e. serves as a retention of the ore or material in process, and allows orientating the ore to be discharged in each conveyor belt by guiding the rejected material and/or concentrate to their corresponding discharge boxes.

The magnetic drum is used to remove iron from iron sands and can separate iron in low-percentage sand, such as 2%. The drum is regulated to operate with approximately 1,500 Gauss magnets.

The process of magnetic separation allows obtaining concentrations higher than 65% ore grade, with a single run treatment.

1. A magnetic drum for the magnetic separation of iron particles from iron sands, comprising:
an outer body or hollow cylindrical casing (2);
two side covers (3) one at each end of the casing; and
an inner part or core (7) which comprises sheet discs (4) which are evenly distributed and attached to a central shaft (6), and at least 18 straight magnetic plates (5) placed radially on the external surface of the core, and which are supported by the discs.

2. The magnetic drum for the magnetic separation of iron particles as described in claim 1, wherein the casing is made of stainless steel and it is approximately 3,000 mm in length and approximately 920 mm in diameter.

3. The magnetic drum for the magnetic separation of iron particles as described in claims 1, wherein the core comprises at least 8 discs, having their corresponding disc reinforcements (10) and wherein the central shaft additionally includes a tube (9) which covers the central portion of the shaft.

4. The magnetic drum for the magnetic separation of iron particles as described in claim 1, wherein the core magnetic plates are at least 18 to 20 magnetic plates and have magnets attached to one of their surfaces.

5. A magnetic drum for the magnetic separation of iron particles as described in claim 4 wherein the magnetic plates present a clearance of approximately 100 to 140 mm between a plate and the other.

6. The magnetic drum for the magnetic separation of iron particles as described in claim 1, wherein the core is made of normal structural iron, the discs are approximately 2 mm in thickness and approximately 890 mm in diameter, the central shaft is made of chrome-nickel steel and it is approximately 3,400 mm in length and approximately 120 mm in diameter, and the magnetic plates are approximately 3,000 mm in length.

7. A magnetic separation system for magnetic separation of iron particles from iron sands comprising:
the magnetic drum as described in claim 1;
two boxes with their support and rotation bearings placed at each end of the drum;
a metal box (8) for holding the drum;
two gear motors with their corresponding shafts and cog belts;
two metal delivery boxes;
an electrical panel having variable frequency drives;
a loading bin; and
a flow regulator.

8. The magnetic separation system for magnetic separation of iron particles according to claim 7 wherein the metal box for holding the drum is approximately 3,200 mm in length and approximately 1,620 mm in width.

9. The magnetic separation system for magnetic separation of iron particles according to claim 7 wherein a bin is installed on the funnel-shaped metal box (8) which has an opening at the bottom from end to end of the funnel, which allows regulating the feeding toward the magnetic drum.

10. A method for assembling the magnetic separation system for the magnetic separation of iron particles from iron sands which comprises:
installing a magnetic drum as described in any of the claims 1 to 6 within a metal box which holds the drum;
installing on both lateral ends of the shaft a mechanical system with cog belts based on two gear motors which exert the drive movement through the chain, where the diameter of the cog belts and the power of the gear motors will depend on the kind of material to be concentrated, for instance sand or magnetite particulate;
connecting the gear motors to an electrical panel in order to control the start and detention of the drum operation;
installing on the upper portion of the magnetic drum a loading bin for the reception of the material to be treated in the drum and at the bottom two discharge metal boxes; and
installing a flow regulator in the lower part of the loading bin, which regulates the feeding on the external surface of the drum, for a feeding flow of approximately 200 tons an hour.

11. The method for assembling the magnetic separation system for the magnetic separation of iron particles from iron sands according to claim 10, wherein the magnetic drum is placed at the center of the metal box, taking precautions to leave a clearance of approximately 500 mm for the delivery of sterile material and a clearance of approximately 200 mm for the iron concentrate;

12. A magnetic separation method for the separation of iron particles from iron sands which comprises:
having at least one system as described in claim 7;
feeding the material to be separated through the loading bin;
starting the system through the electrical panel in such a way that each gear motor gives an inverse movement to the casing and to the core, and when the drum is loaded by the flow regulator, the iron particles follow the rotating direction of the magnetic core and are received by one of the discharge metal boxes, which transfers them to the conveyor belt for collection, whereas the non magnetic particles follow the rotating direction of the casing and are received by the other discharge metal box, which transfers them to the rejection or non magnetic particle conveyor belt.

13. The magnetic separation method for the separation of iron particles from iron sands according to claim 12 wherein the metal box (8) allows supporting and feeding the magnetic drum, also preventing the magnetic material from being lost out of the box during the concentration and/or rejection process, and which allows orientating the ore to be discharged in each conveyor belt by guiding the rejected material and/or concentrate to their corresponding discharge boxes.
